(19) United States
(12) Patent Application Publication
(10) Pub. No.: US 2019/0289418 A1
(43) Pub. Date: Sep. 19, 2019

(54) METHOD AND APPARATUS FOR REPRODUCING AUDIO SIGNAL BASED ON MOVEMENT OF USER IN VIRTUAL SPACE

(71) Applicant: Electronics and Telecommunications Research Institute, Daejeon (KR)

(72) Inventor: Dae Young JANG, Daejeon (KR)

(73) Assignee: Electronics and Telecommunications Research Institute, Daejeon (KR)

(21) Appl. No.: 16/207,252

(22) Filed: Dec. 3, 2018

(30) Foreign Application Priority Data
Mar. 16, 2018 (KR) 10-2018-0030845

(51) Int. Cl. H04S 7/00; H04S 3/00

(52) U.S. Cl. CPC H04S 7/303; H04S 3/008; H04S 2400/01; H04S 2400/11; H04S 2420/01; H04S 2400/13

(57) ABSTRACT

Provided is a method of reproducing an audio signal, the method including determining, when a user moves from a position to another position in a virtual space, a relative position between a sound source and the other position of the user using metadata based on a movement of the user and correcting a first audio signal obtained from the sound source at the position of the user to a second audio signal obtained from the sound source at the other position of the user based on the relative position.

### CROSS-REFERENCE TO RELATED APPLICATION(S)

This application claims the priority benefit of Korean Patent Application No. 10-2018-0030845 filed on Mar. 16, 2018, in the Korean Intellectual Property Office, the disclosure of which is incorporated herein by reference for all purposes.

### BACKGROUND

### 1. Field

One or more example embodiments relate to a method and an apparatus for reproducing an audio signal based on a movement of a user in a virtual space and, more particularly, to a method and apparatus for reproducing an audio signal corrected by determining a relative position between a user and a sound source in a virtual space.

### 2. Description of Related Art

In a virtual reality (VR) environment, a stereo sound may be reproduced by adjusting a direction of a virtual multichannel speaker through a head tracking based on a headphone in response to a change in a head direction.

In the case of object-based audio that utilizes computer graphics images, such as a game, a 3D position of an object sound source may be reproduced in more detail by rendering a direction and distance from the object sound source through the head tracking. However, when recorded in real space, it is difficult to represent all sounds as the object-based audio, so an audio in a hybrid format including a channel-based audio and the object-based audio is used. At present, the hybrid format audio is used mainly for movie contents in Dolby Atmos and DTS-X, and used mainly for broadcast contents in Dolby AC4 and Moving Picture Experts Group (MPEG)-H 3D Audio.

Therefore, in a three degrees of freedom (DoF) environment in which a user moves the head only at a fixed position, the audio in the hybrid format can be applied. However, in a 6DoF environment in which the user freely moves in the virtual space, it is difficult to accurately reproduce the stereo sound based on a position of the user when using the channel-based audio.

### SUMMARY

An aspect provides a method and an apparatus for reproducing an audio signal based on a movement of a user in a virtual space to correct a channel-based audio so that a stereo sound is represented based on a position to which the user moves when the user moves in the virtual space.

Another aspect also provides a method and an apparatus for reproducing an audio signal based on a movement of a user in a virtual space to reproduce a stereo sound corresponding to a position to which the user moves using metadata including virtual space information.

Another aspect also provides a method and an apparatus for reproducing an audio signal based on a movement of a user in a virtual space to reproduce a stereo sound corresponding to a position to which the user moves by determining a relative position between a sound source and a head of the user based on metadata even when the user is moving.

According to an aspect, there is provided a method of reproducing an audio signal, the method including determining, when a user moves from a position to another position in a virtual space, a relative position between a sound source and the other position of the user using metadata based on a movement of the user and correcting a first audio signal obtained from the sound source at the position of the user to a second audio signal obtained from the sound source at the other position of the user based on the relative position.

The metadata may include at least one of information on a virtual space including the sound source and information on a position of the sound source in the virtual space.

The second audio signal may be obtained by applying an acoustic effect corresponding to the other position to the first audio signal.

The determining of the relative position may include determining the relative position based on a direction and a distance between the user and the sound source using information included in the metadata.

The correcting of the first audio signal may include correcting the first audio signal to the second audio signal by applying a delay time and a gain based on the movement of the user.

The delay time may be determined by comparing a distance between the position of the user and the sound source and a distance between the other position of the user and the sound source and the first sound signal may be corrected to the second audio signal by applying the delay time.

The gain may increase when a distance between the position of the user and the sound source is less than a distance between the other position of the user and the sound source, and the gain may decrease when the distance between the position of the user and the sound source is greater than the distance between the other position of the user and the sound source.

The correcting may include correcting, when the distance between the user and the sound source decreases, the first audio signal to the second audio signal such that a direct sound from the sound source increases and a reverberation decreases, or correcting, when the distance between the user and the sound source increases, the first audio signal to the second audio signal such that the direct sound from the sound source decreases and the reverberation increases.

According to another aspect, there is also provided a method of generating an audio signal, the method including receiving an audio signal from a sound source located in a recording space and generating, when a user moves from a position to another position in a virtual space, metadata used for determining a relative position between the other position and the sound source based on a movement of the user.

The metadata may include at least one of information on the virtual space including the sound source and information on a position of the sound source in the virtual space.

According to another aspect, there is also provided an apparatus for reproducing an audio signal, the apparatus including a processor, wherein the processor is configured to determine, when a user moves from a position to another position in a virtual space, a relative position between a sound source and the other position of the user using metadata based on a movement of the user and correct a first audio signal obtained from the sound source at the position of the user to a second audio signal obtained from the sound source at the other position of the user based on the relative position.

The metadata may include at least one of information on a virtual space including the sound source and information on a position of the sound source in the virtual space.

The second audio signal may be obtained by applying an acoustic effect corresponding to the other position to the first audio signal.

The processor may be configured to determine the relative position based on a direction and a distance between the user and the sound source using information included in the metadata.

When correcting the first audio signal to the second audio signal from the sound source at the other position of the user, the processor may be configured to correct the first audio signal to the second audio signal by applying a delay time and a gain based on the movement of the user.

The delay time may be determined by comparing a distance between the position of the user and the sound source and a distance between the other position of the user and the sound source, and the first sound signal may be corrected to the second audio signal by applying the delay time.

The gain may increase when a distance between the position of the user and the sound source is less than a distance between the other position of the user and the sound source, and the gain may decrease when the distance between the position of the user and the sound source is greater than the distance between the other position of the user and the sound source.

When the distance between the user and the sound source decreases, the processor may be configured to correct the first audio signal to the second signal such that a direct sound from the sound source increases and a reverberation decreases, or when the distance between the user and the sound source increases, the processor may be configured to correct the first audio signal to the second signal such that the direct sound from the sound source decreases and the reverberation increases.

According to another aspect, there is also provided an apparatus for generating an audio signal, the apparatus including a processor, wherein the processor is configured to identify an audio signal received from a sound source located in a recording space and generate, when a user moves from a position to another position in a virtual space, metadata used for determining a relative position between the other position and the sound source based on a movement of the user.

The metadata may include at least one of information on the virtual space including the sound source and information on a position of the sound source in the virtual space.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating an example of providing a stereo sound to a user in a virtual space according to an example embodiment;

FIG. 2 is a diagram illustrating a user listening to an orchestra performance according to an example embodiment;

FIG. 3 is a diagram illustrating a user listening to an orchestra performance in a state in which a movement of the user in a virtual space is not applied according to an example embodiment;

FIG. 4 is a diagram illustrating a user listening to an orchestra performance in a state in which a movement of the user in a virtual space is applied according to an example embodiment;

FIG. 5 is a diagram illustrating a user listening to an orchestra performance in a state in which a movement of the user in a virtual space is not applied according to an example embodiment;

FIG. 6 is a diagram illustrating a user listening to an orchestra performance in a state in which a movement of the user in a virtual space is applied according to an example embodiment;

FIG. 7 is a diagram illustrating an example of determining a gain and a delay time at another position to which a user is moved according to an example embodiment;

FIG. 8 is a diagram illustrating an audio signal reproduction method performed by an audio signal reproduction apparatus according to an example embodiment; and

FIG. 9 is a diagram illustrating an audio signal generation method performed by an audio signal generation apparatus according to an example embodiment.

### DETAILED DESCRIPTION

Detailed example embodiments of the inventive concepts are disclosed herein. However, specific structural and functional details disclosed herein are merely representative for purposes of describing example embodiments of the inventive concepts. Example embodiments of the inventive concepts may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the inventive concepts. As used herein, the term “and/or” includes any and all combinations of one or more of the associated listed items.

It will be understood that when an element is referred to as being “connected” or “coupled” to another element, it may be directly connected or coupled to the other element or intervening elements may be present.

The terminology used herein is for the purpose of describing particular embodiments only and is not intended to be limiting of example embodiments of the inventive concepts. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, example embodiments will be described in detail with reference to the accompanying drawings.

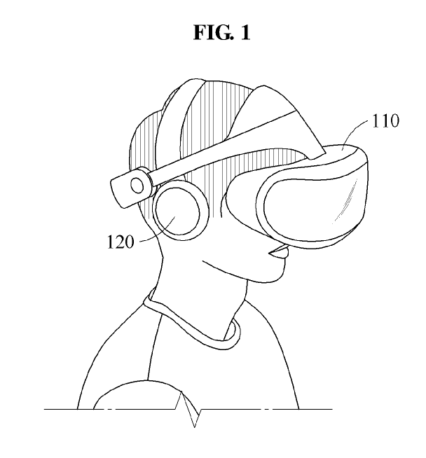

FIG. 1 is a diagram illustrating an example of providing a stereo sound to a user in a virtual space according to an example embodiment.

A user may use a virtual reality (VR) device 110 to experience a virtual reality or a virtual space. For example, the user may experience the same experience as participating in an orchestra performance or a concert in the virtual space using the VR device 110 without having to attend the orchestral performance or concert. By using the VR device 110, the user in the virtual space may experience the orchestral performance or concert in a concert hall. Here, the orchestral performance or concert is merely an example.

The user may use a reproduction device 120 to listen to a sound corresponding to the virtual space of the VR device 110. The reproduction device 120 may be worn on a part of a body of the user or located near an ear of the user to provide the sound. The reproduction device 120 may be provided in various forms according to a purpose of the user and may provide various functions. The reproduction device 120 may provide a realistic stereo sound to the user in the virtual space. The reproduction device 120 may include, for example, a headset, a headphone, an earpiece, and hearing aids.

The reproduction device 120 may reproduce a sound corresponding to a VR image viewed by the user through the VR device 110. For example, when the user moves in the virtual space while viewing the orchestra performance using the VR device 110, the user may listen to different sound from the orchestra performance using the reproduction device 120 in accordance with a movement.

In an example, the user viewing the orchestra performance in the concert hall using the VR device 110 in the virtual space may use a headphone corresponding to the reproduction device 120 to listen to the orchestra performance. In this example, the headphone may provide the user in the virtual space with the same stereo sound as in an actual concert hall.

When an orchestra and a vocalist perform together, the orchestra performance may be output through a multichannel speaker as a channel-based audio signal and a vocal may be an object-based audio signal. A hybrid format audio signal may include a channel-based audio signal and an object-based audio signal. The channel-based audio signal and the object-based audio signal may be transmitted and/or reproduced independently.

When the user wearing the VR device 110 approaches a stage on which the orchestra is performing in the virtual space, the headphone may provide a stereo sound in which a direct sound is heard greater and a reverberation is heard smaller as if the user is in the actual concert hall. When the user wearing the VR device 110 moves away from the stage, the headphone may provide a stereo sound in which a direct sound in the virtual space is heard smaller and a reverberation is heard louder as if the user is in the actual concert hall.

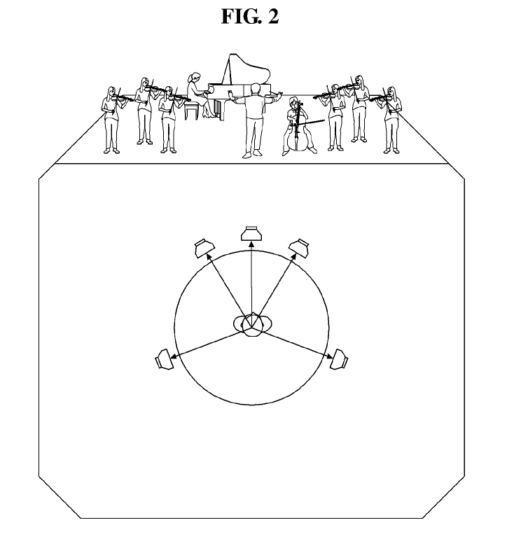

FIG. 2 is a diagram illustrating a user listening to an orchestra performance according to an example embodiment.

A user wearing the VR device 110 may view an orchestra performance in a virtual space. The user wearing a reproduction device, for example, a headphone may listen to the orchestra performance as if the user is in an actual concert hall. When an orchestra and a vocalist perform together, an orchestra performance may be a channel-based audio signal and a vocal may be an object-based audio signal. The channel-based audio signal and the object-based audio signal may be transmitted and/or reproduced independently. The user wearing the headphone may listen to the performance of the orchestra and the vocalist as if the user is in the actual concert hall.

The virtual space may be set to be the same as or different from the actual concert hall. For example, the user may experience a performance in the same virtual space as the actual concert hall. Also, the user may experience the performance in a virtual space set to be different from the actual concert hall.

The virtual space different from the actual concert hall may be set by the user. In one example, when the actual concert hall is indoors, the user may set the virtual space to be an outdoor performance and experience the outdoor performance. In another example, the user may select a concert hall different from the actual concert hall and experience the performance in the different concert hall. In another example, the user may select home instead of the actual concert hall and experience the performance at home. The virtual space set by the user is not limited to the examples.

A location at which the orchestra performs may be a position of a sound source. In the sound source, an audio signal may be generated. For example, audio signals may be generated based on the orchestra performance corresponding to the sound source.

The user may listen to the performance using a reproduction device, for example, a multichannel speaker as if the user is in the actual concert hall. Using the multichannel speaker including five speakers, the user may listen to the performance as if the user is in the actual concert hall.

The user may listen to the performance using a reproduction device, for example, a headphone as if the user is in the actual concert hall. When a virtual speaker by the headphone is rendered to be the same as the multichannel speaker, the user may listen to the same performance as the multichannel speaker using the headphone.

In order to reproduce a stereo sound, an audio signal reproduction method for various channels such as a 7.1 channel, a 10.2 channel, a 9.1 channel, and an 11.1 channel may be used as well as an audio signal reproduction method for a six degrees of freedom (DoF) user movement for a 5.1 channel.

Two or more multichannel microphone sets may be used when recording. Also, when a position of each microphone set is known in advance, 6DoF audio reproduction may be allowed through a combination of two multichannel audio signals. For example, in terms of two or more cameras and/or microphone sets neighboring at a known distance, the same image and/or audio object may be detected through a pattern matching based on a correlation so that coordinates of an actual object is extracted by a line extending from a directional angle of the same object. Thus, the 6DoF audio reproduction may be performed based on the coordinates of the actual object through the combination of two or more multichannel audio signals.

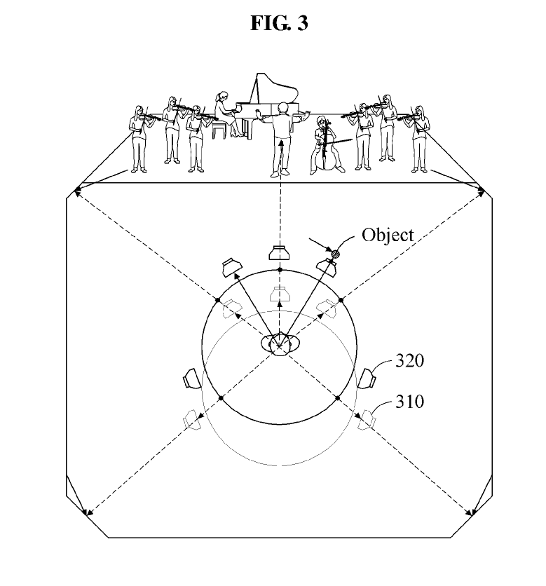

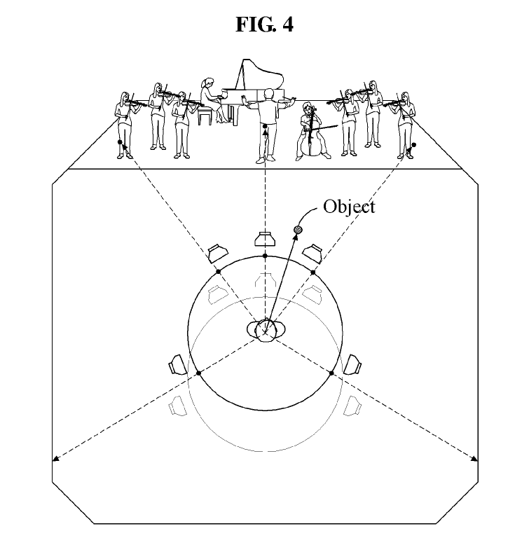

FIG. 3 is a diagram illustrating a user listening to an orchestra performance in a state in which a movement of the user in a virtual space is not applied according to an example embodiment. FIG. 4 is a diagram illustrating a user listening to an orchestra performance in a state in which a movement of the user in a virtual space is applied according to an example embodiment.

Referring to FIG. 3, when a user uses a multichannel speaker 310 to listen to an orchestra performance, a movement of the user in a concert hall of a virtual space may not be applied by the VR device 110 because the user recognizes a direction of a sound source using the multichannel speaker. Thus, the user may listen to a distorted orchestra performance using the multichannel speaker to which the movement is not applied. That is, a distortion may occur between a position of a sound source viewed by the user in the virtual space and a position of a sound source heard by the user, so that the user hears the distorted orchestra performance.

In addition, referring to FIG. 3, a position of an object may be distorted due to a movement of the user. When a fixed position of the object is used without applying a relative position of the object based on the movement of the user, the position of the object may be distorted due to the movement of the user.

Also, referring to FIG. 3, even when the user listens to the orchestra performance using a virtual speaker 320 of a headphone, the movement of the user in the concert hall of the virtual space may not be applied by the VR device 110. For example, when the user approaches the sound source, a direct sound from the sound source may increase and a reverberation may decrease. Also, when the user moves away from the sound source, the direct sound from the sound source may decrease and the reverberation may increase. However, an acoustic effect such as changes in the direct sound and the reverberation based on the movement of the user may not be applied to the virtual speaker 320. Thus, a distortion may occur between a position of a sound source viewed by the user in the virtual space and a position of a sound source heard by the user, so that the user hears the distorted orchestra performance.

[symbol] he user in the virtual space may hear different orchestra performances based on the movement in the virtual space. A position at which an orchestra performs in the virtual space may be a position of a sound source. That is, the position of the sound source may be a position of the sound source in the concert hall corresponding to the virtual space instead of the multichannel speaker or the virtual speaker. Thus, when using the position of the sound source and a new position of the user, the distortion may not occur between the position of the sound source viewed by the user in the virtual space and the position of the sound source heard by the user so that the user hears the orchestra performance without distortion.

Unlike the example of FIG. 3, in the example of FIG. 4, as a result of reflecting the relative position of the object and the user based on the movement of the user and the relative position of the user and the orchestra performance, the object and the orchestra performance may be heard by the user as if the user is in the actual concert hall despite the movement of the user. For example, when mixing with a multichannel audio by applying the relative position of the object corresponding to a changed position of the user, a sound may be heard as if an absolute position of the object is fixed.

Referring to FIG. 4, the position of the sound source at which the orchestra performs may be a set position including the sound source in the virtual space instead of a position of the virtual speaker of the headphone. When the virtual space is a concert hall, the position of the sound source may be a position of a stage at which the orchestra performs.

When the user moves from a position to another position in the virtual space, a relative position between the position of the sound source and the other position of the user may change. That is, a relative position between the position of the user and the position of the sound source may be different from a relative position between the other position of the user and the position of the sound source. Thus, an orchestra performance heard by the user at the position in the concert hall corresponding to the virtual space may be different from an orchestra performance heard by the user at the other position. However, unlike the example of FIG. 3, the distortion may not occur between the position of the sound source viewed by the user in the virtual space and the position of the sound source heard by the user.

In this example, different orchestra performances may be heard based on a distance between the other position of the user and the position of the sound source. Also, different orchestra performances may be heard based on a direction between the other position of the user and the position of the sound source.

Metadata may include at least one of virtual space information and information on a position of a sound source in a virtual space. Here, the virtual space information may include information associated with a structure of a virtual space including a sound source, a wall of the virtual space, and a characteristic of the virtual space. Also, the information on the position of the sound source may include the position of the sound source in the virtual space. Thus, a first audio signal obtained from an orchestra performance heard by the user at the position in the virtual space may be corrected to a second audio signal obtained from an orchestra performance heard by the user at the other position to which the user moves. Thus, the distortion may not occur between the position of the sound source viewed by the user in the virtual space and the position of the sound source heard by the user.

By adding the information on the position of the sound source between channels as well as a distance from the sound source in each channel direction of a multichannel microphone to contents as the metadata, the position of the sound source between the channels may be controlled to be a relative position according to a movement of a listener in conjunction with a sound source separation.

The second audio signal may be obtained by applying an acoustic effect corresponding to the other position to the first audio signal. For example, the first audio signal may be corrected to be the second audio signal by applying, to the first audio signal, an acoustic effect of, for example, changing a reverberation, reproducing a realistic stereo sound using a resonance frequency, and changing a direct sound from the sound source by applying a distance from a wall in response to a movement of the user.

Here, the virtual space may be the same as or different from a recording space. The orchestra performance that the user listens to may be previously recorded and reproduced to the user in the virtual space. The orchestra performance may be recoded in an actual space instead of the virtual space. In this example, the actual space may be the recording space.

For example, the recording space for recording the orchestra performance may be the same concert hall as that of the virtual space in which the orchestra performance is reproduced. Also, the recording space and the virtual space may be different concert halls. When the recording space and the virtual space are the same concert hall, the virtual space information may include information associated with a structure of the recording space, a wall of the recording space, and a characteristic of the recording space. When the recording space and the virtual space are different concert halls, the virtual space information may include information associated with a structure of the virtual space, a wall of the virtual space, and a characteristic of the virtual space instead of those of the recording space.

In the example of FIG. 3, the distortion may occur between the position of the sound source viewed by the user in the virtual space and the position of the sound source heard by the user due to the movement of the user. In the example of FIG. 4, the distortion may not occur between the position of the sound source viewed by the user in the virtual space and the position of the sound source heard by the user despite the movement of the user.

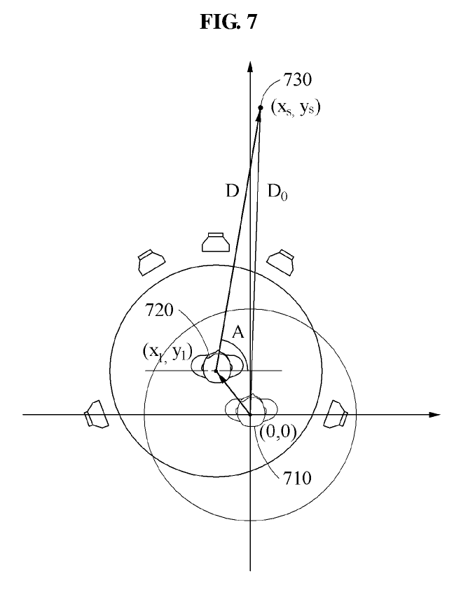

The second audio signal may be determined by applying a gain and a delay time to the first audio signal based on the corrected direction and distance between the other position of the user and the position of the sound source. Here, the delay time may increase when a distance between the position and the other position of the user is relatively large. Also, the delay time may decrease when the distance between the position and the other position of the user is relatively small. Also, the gain may decrease when a distance between the position of the user and the position of the sound source is relatively large, and may increase when the distance between the position of the user and the position of the sound source is relatively small. A method of determining the gain and the delay time will be further described with reference to FIG. 7.

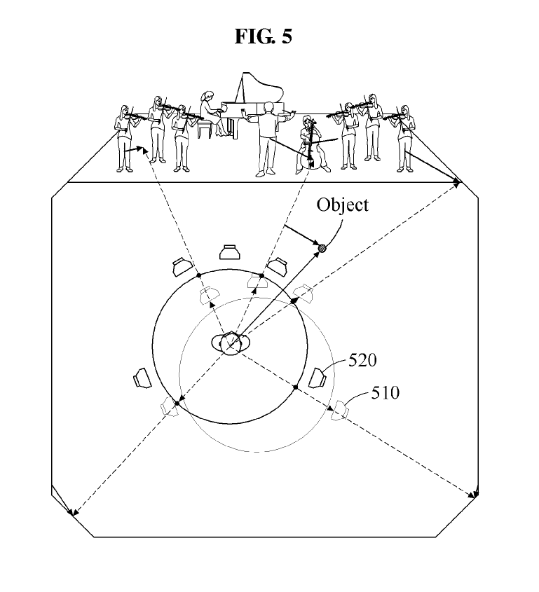

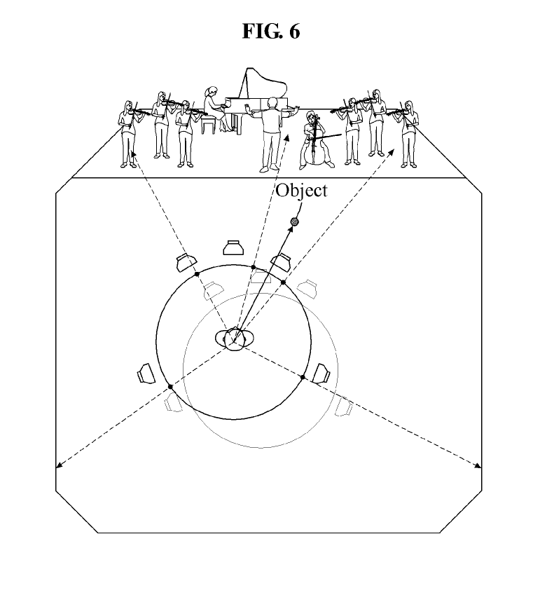

FIG. 5 is a diagram illustrating a user listening to an orchestra performance in a state in which a movement of the user in a virtual space is not applied according to an example embodiment. FIG. 6 is a diagram illustrating a user listening to an orchestra performance in a state in which a movement of the user in a virtual space is applied according to an example embodiment.

FIGS. 5 and 6 shows different movements of a user in the virtual space of FIGS. 3 and 4. In the examples of FIGS. 3 and 4, the user may move forward. In the examples of FIGS. 5 and 6, the user may move diagonally. The description of FIGS. 3 and 4 may also be applied to FIGS. 5 and 6.

Referring to FIG. 5, when a user uses a multichannel speaker 510 to listen to an orchestra performance, a movement of the user in a concert hall of a virtual space may not be applied by the VR device 110 because the user recognizes a direction of a sound source using the multichannel speaker. Thus, the user may listen to a distorted concert sound using the multichannel speaker to which the movement is not applied. That is, a distortion may occur between a position of a sound source viewed by the user in the virtual space and a position of a sound source heard by the user, so that the user hears the distorted orchestra performance.

In addition, referring to FIG. 5, a position of an object may be distorted due to a movement of the user. When a fixed position of the object is used without applying a relative position of the object based on the movement of the user, the position of the object may be distorted due to the movement of the user.

Also, referring to FIG. 5, even when the user hears the orchestra performance using a virtual speaker 520 of a headphone, the movement of the user in the concert hall of the virtual space may not be applied by the VR device 110. For example, when the user approaches the sound source, a direct sound from the sound source may increase and a reverberation may decrease. Also, when the user moves away from the sound source, the direct sound from the sound source may decrease and the reverberation may increase. However, an acoustic effect such as changes in the direct sound and the reverberation based on the movement of the user may not be applied to the virtual speaker 520. Thus, a distortion may occur between a position of a sound source viewed by the user in the virtual space and a position of a sound source heard by the user, so that the user hears the distorted orchestra performance.

The user in the virtual space may hear different orchestra performances based on the movement in the virtual space. A position at which an orchestra performs in the virtual space may be a position of a sound source. That is, the position of the sound source may be a position of the sound source in the concert hall corresponding to the virtual space instead of the multichannel speaker or the virtual speaker. Thus, when using the position of the sound source and a new position of the user, the distortion may not occur between the position of the sound source viewed by the user in the virtual space and the position of the sound source heard by the user so that the user hears the orchestra performance without distortion.

Unlike the example of FIG. 5, in the example of FIG. 6, as a result of reflecting the relative position of the object and the user based on the movement of the user and the relative position of the user and the orchestra performance, the object and the orchestra performance may be heard by the user as if the user is in the actual concert hall despite the movement of the user. For example, when mixing with a multichannel audio by applying the relative position of the object corresponding to a changed position of the user, a sound may be heard as if an absolute position of the object is fixed.

Referring to FIG. 6, the position of the sound source at which the orchestra performs may be a set position including the sound source in the virtual space instead of a position of the virtual speaker of the headphone. When the virtual space is a concert hall, the position of the sound source may be a position of a stage at which the orchestra performs.

When the user moves from a position to another position in the virtual space, a relative position between the position of the sound source and the other position of the user may change. That is, a relative position between the position of the user and the position of the sound source may be different from a relative position between the other position of the user and the position of the sound source. Thus, an orchestra performance heard by the user at the position in the concert hall corresponding to the virtual space may be different from an orchestra performance heard by the user at the other position. However, unlike the example of FIG. 5, the distortion may not occur between the position of the sound source viewed by the user in the virtual space and the position of the sound source heard by the user.

In this example, different orchestra performances may be heard based on a distance between the other position of the user and the position of the sound source. For example, when a distance between the user and the sound source increases, the user may hear a sound in which a direct sound of the orchestra performance is decreased and a reverberation is increased.

Also, different orchestra performances may be heard based on a direction between the other position of the user and the position of the sound source. For example, when the user changes an orientation at the same position, the user may hear a different orchestra performance because a direction of the head of the user listening to the orchestra performance has changed.

When the user moves to another position where a distance and a direction from the previous position are changed, the user may hear an orchestra performance different from the orchestra performance heard at the previous position at the other position.

Metadata may include at least one of virtual space information and information on a position of a sound source in a virtual space. Here, the virtual space information may indicate information associated with a structure of a virtual space including a sound source, a wall of the virtual space, and a characteristic of the virtual space. Also, the information on the position of the sound source may indicate the position of the sound source in the virtual space. Thus, a first audio signal obtained from an orchestra performance heard by the user at the position in the virtual space may be corrected to a second audio signal obtained from an orchestra performance heard by the user at the other position to which the user moves. Thus, the distortion may not occur between the position of the sound source viewed by the user in the virtual space and the position of the sound source heard by the user.

The second audio signal may be obtained by applying an acoustic effect corresponding to the other position to the first audio signal. For example, the first audio signal may be corrected to be the second audio signal by applying, to the first audio signal, an acoustic effect of, for example, changing a reverberation, reproducing a realistic stereo sound using a resonance frequency, and changing a direct sound from the sound source by applying a distance from a wall in response to a movement of the user.

Here, the virtual space may be the same as or different from a recording space. The orchestra performance that the user listens to may be previously recorded and reproduced to the user in the virtual space. The orchestra performance may be recoded in an actual space instead of the virtual space. In this example, the actual space may be the recording space.

For example, the recording space for recording the orchestra performance may be the same concert hall as that of the virtual space in which the orchestra performance is reproduced. Also, the recording space and the virtual space may be different concert halls. When the recording space and the virtual space are the same concert hall, the virtual space information may include information associated with a structure of the recording space, a wall of the recording space, and a characteristic of the recording space. When the recording space and the virtual space are different concert halls, the virtual space information may include information associated with a structure of the virtual space, a wall of the virtual space, and a characteristic of the virtual space instead of those of the recording space.

In the example of FIG. 5, the distortion may occur between the position of the sound source viewed by the user in the virtual space and the position of the sound source heard by the user due to the movement of the user. In the example of FIG. 6, the distortion may not occur between the position of the sound source viewed by the user in the virtual space and the position of the sound source heard by the user despite the movement of the user.

The second audio signal may be determined by applying a gain and a delay time to the first audio signal based on the corrected direction and distance between the other position of the user and the position of the sound source. Here, the delay time may increase when a distance between the position and the other position of the user is relatively large. Also, the delay time may decrease when the distance between the position and the other position of the user is relatively small. Also, the gain may decrease when a distance between the position of the user and the position of the sound source is relatively large, and may increase when the distance between the position of the user and the position of the sound source is relatively small. A method of determining the gain and the delay time will be further described with reference to FIG. 7.

FIG. 7 is a diagram illustrating an example of determining a gain and a delay time at a new position based on a movement of a user according to an example embodiment.

A user may move from a position 710 (0,0) to another position 720 (X₁, Y₁). The user may hear a first audio signal from a sound source position 730 (Xₛ, Yₛ) at the position 710. The user may hear a second audio signal from the sound source position 730 at the other position 720.

When the user is at the position (0,0), the user may determine that a sound source is heard from the sound source position (Xₛ, Yₛ) and it is determined that a sound source viewed by the user is located at the position (Xₛ, Yₛ). Likewise, when the user is at the other position (X₁, Y₁), the may determine that a sound source is heard from the sound source position (Xₛ, Yₛ) and it is determined that a sound source viewed by the user is located at the position (Xₛ, Yₛ).

A distance Do between the position 710 (0,0) and the sound source position 730 (Xₛ, Yₛ) may be determined using Equation 1.

D₀=((xₛ)²+(yₛ)²)^{1/2} [Equation 1]

A distance D between the other position 720 (X₁, Y₁) and the sound source position 730 (Xₛ, Yₛ) may be determined using Equation 2.

D=((xₛ−x₁)²+(yₛ−y₁)²)^{1/2} [Equation 2]

The second audio signal received from the sound source at the other position 720 (X₁, Y₁) may be determined by applying a gain to the first audio signal received from the sound source at the position 710 (0,0). In this example, the gain may be determined using Equation 3.

G=(D₀/D)² [Equation 3]

In one example, when the distance D between the other position (X₁, Y₁) of the user and the sound source (Xₛ, Yₛ) is less than the distance Do between the position (0,0) of the user to the sound source (Xₛ, Yₛ), a gain of the second audio signal heard by the user at the other position may increase as compared to the first audio signal.

In another example, when the distance D between the other position (X₁, Y₁) of the user and the sound source (Xₛ, Yₛ) is greater than the distance Do between the position (0,0) of the user to the sound source (Xₛ, Yₛ), the gain of the second audio signal heard by the user at the other position may decrease as compared to the first audio signal.

The second audio signal received from the sound source at the other position 720 (X₁, Y₁) may be determined by applying a delay time to the first audio signal received from the sound source at the position 710 (0,0). In this example, the delay time may be determined using Equation 4. In Equation 4, V denotes a propagation speed of a sound

T(sec)=(D−D₀)/V [Equation 4]

In one example, when the distance Do between the position (0,0) of the user to the sound source (Xₛ, Yₛ) is less than the distance D between the other position (X₁, Y₁) of the user and the sound source (Xₛ, Yₛ), the first audio signal may be delayed by a delay time T and corrected to be the second audio signal.

In another example, when the distance Do between the position (0,0) of the user to the sound source (Xₛ, Yₛ) is greater than the distance D between the other position (X₁, Y₁) of the user and the sound source (Xₛ, Yₛ), a delay time T corresponding to a negative value may be applied to the first audio signal so that the first audio signal is corrected to be the second audio signal.

As such, the delay time may be determined by comparing the distance between the position of the user and the sound source and the distance between the other position of the user and the sound source. Also, the delay time may be applied to the first audio signal so that the first audio signal is corrected to be the second audio signal.

Thus, by applying the gain and the delay time determined using Equations 3 and 4 to the first audio signal, the second audio signal received from the sound source (Xₛ, Yₛ) at the other position 720 (X₁, Y₁) may be determined as shown in Equation 5.

S₂(n)=G*S₁(n+T). [Equation 5]

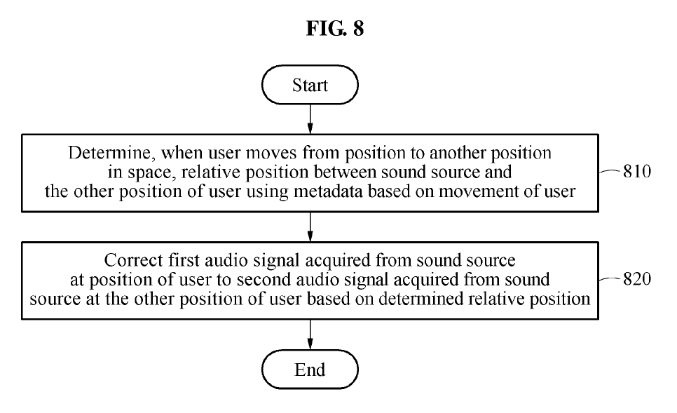

FIG. 8 is a diagram illustrating an audio signal reproduction method performed by an audio signal reproduction apparatus according to an example embodiment.

In operation 810, when a user moves from a position to another position in a virtual space, an audio signal reproduction apparatus may determine a relative position between a sound source and the other position of the user using metadata based on a movement of the user.

The metadata may include at least one of virtual space information of a virtual space including the sound source and information on a position of the sound source in the virtual space. Here, the virtual space information may include information associated with a structure of a virtual space including a sound source, a wall of the virtual space, and a characteristic of the virtual space. Also, the information on the position of the sound source may include the position of the sound source in the virtual space. Thus, a first audio signal obtained from an orchestra performance heard by the user at the position in the virtual space may be corrected to a second audio signal obtained from an orchestra performance heard by the user at the other position to which the user moves. Thus, a distortion may not occur between a position of the sound source viewed by the user in the virtual space and a position of the sound source heard by the user.

A position of the user may be a position from which the user is to move, and another position of the user may be a position to which the user is moved. For example, when the user moves from a center of a concert hall to a position close to a stage, the center of the concert hall may be a position and the position close to the stage may be another position.

In an example, the relative position between the user and the sound source may be determined to provide an undistorted stereo sound to the user in the virtual space based on a movement of the user.

Thus, when determining the relative position between the user and the sound source, the audio signal reproduction apparatus may determine the relative position based on a direction and a distance between the user and the sound source using information included in the metadata.

The audio signal reproduction apparatus may verify a position of the sound source using the metadata. Also, the audio signal reproduction apparatus may verify the other position based on the movement and the position of the user. Thus, the audio signal reproduction apparatus may verify a relative position between the position of the user and the position of the sound source and verify a relative position between the position of the other position of the user and the position of the sound source.

In one example, when the orchestra performs on the stage of the concert hall and the user moves from the center of the concert hall to the position close to the stage, the audio signal reproduction apparatus may verify a relative position between the stage and the center of the concert hall and verify a relative position between the stage and the position close to the stage.

In another example, when the orchestra performs on the stage of the concert hall and the user diagonally moves from the center of the concert hall to the position close to the stage, the audio signal reproduction apparatus may verify a relative position between the stage and the center of the concert hall and verify a relative position between the stage and the position close to the stage.

In addition to a distance between the user and the stage, a direction between the user and the stage may also be considered. As such, when determining a relative position, the direction between the user and the sound source may be considered together with the distance therebetween.

In operation 820, the audio signal reproduction apparatus may correct a first audio signal obtained from the sound source at the position of the user to a second audio signal obtained from the sound source at the other position of the user based on the relative position.

The first audio signal may be corrected to be the second audio signal by applying an acoustic effect corresponding to the other position to the first audio signal. The acoustic effect may refer to an effect applied to reproduce a stereo sound such as a delay time, a gain, a direct sound, and a reverberation.

The gain may increase when a distance between the position of the user and the sound source is relatively small. Also, the gain may decrease when the distance between the position of the user and the sound source is relatively large.

When the distance between the user and the sound source decreases, a direct sound from the sound source may increase and a reverberation may decrease. When the distance between the user and the sound source increases, the direct sound from the sound source may decrease and the reverberation may increase.

For example, when the user moves from the center of the concert hall to the position close to the stage, a gain may increase, a direct sound from the sound source may increase, and a reverberation may decrease. Also, when the user moves from the center of the concert hall to be away from the stage, the gain may decrease, the direct sound from the sound source may decrease, and the reverberation may increase.

When only the direction between the sound source and the user is considered in 6DoF and the distance therebetween is not taken into consideration, a stereo sound may not be reproduced due to the distortion. By using the metadata including the virtual space information and/or the information of the position of the sound source, the stereo sound may be reproduced based on the distance and the direction even when the user moves.

An audio signal recorded using a multichannel microphone in a recording space may be reproduced. By analyzing the recorded audio signal, an object-based audio may be controlled based on a separated sound source signal and a position of a sound source using a sound source separation technique for separating a sound source and estimating a direction and a position of the sound source.

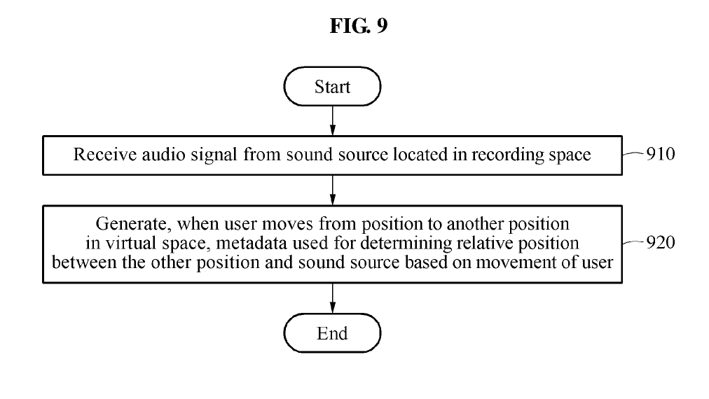

FIG. 9 is a diagram illustrating an audio signal generation method performed by an audio signal generation apparatus according to an example embodiment.

In operation 910, an audio signal generation apparatus may receive an audio signal from a sound source located in a recording space.

Here, the recording space may be an actual space instead of a virtual space. An audio signal generated from the sound source may be recorded in the recording space and reproduced in the virtual space. For example, when the recording space is the concert hall, an orchestra performance may be recorded in the concert hall so that the recorded orchestra performance is reproduced in the virtual space.

In operation 920, when a user moves from a position to another position in a virtual space, the audio signal generation apparatus may generate metadata used for determining a relative position between the other position and the sound source based on a movement of the user.

The user in the concert hall of the virtual space may listen to the orchestra performance as if the user is in a concert hall of the actual space. As the orchestra performance is differently heard based on a position of the user in the concert hall of the actual space, the user may also hear the orchestra performance differently based on the movement of the user in the virtual space. Thus, the relative position between the user and the sound source may be determined to provide the stereo sound to the user in the virtual space.

The metadata may be used to determine the relative position. The metadata may include at least one of information on a virtual space including the sound source and information on a position of the sound source in the virtual space.

Here, the information on the virtual space including the sound source may include information associated with a structure of the virtual space in which an orchestra performs, a wall of the virtual space, and a characteristic of the virtual space. For example, when the virtual space is the same concert hall as the recording space, the metadata may include information on a structure, a wall, and a characteristic of the concert hall corresponding to the recording space.

The metadata may include information on a position of the sound source. The information may include information on a position of the sound source in the virtual space. Thus, the relative position between the user and the sound source may be determined using the metadata.

According to example embodiments, it is possible to correct a channel-based audio so that a stereo sound is reproduced based on a position to which a user moves when the user moves in a virtual space of a 6DoF environment.

According to example embodiments, it is possible to reproduce a stereo sound corresponding to a position to which a user moves based on metadata including virtual space information.

According to example embodiments, it is possible to reproduce a stereo sound corresponding to a position to which a user moves by determining a relative position between a sound source and a head of the user based on metadata even when the user is moving.

The components described in the exemplary embodiments of the present invention may be achieved by hardware components including at least one DSP (Digital Signal Processor), a processor, a controller, an ASIC (Application Specific Integrated Circuit), a programmable logic element such as an FPGA (Field Programmable Gate Array), other electronic devices, and combinations thereof. At least some of the functions or the processes described in the exemplary embodiments of the present invention may be achieved by software, and the software may be recorded on a recording medium. The components, the functions, and the processes described in the exemplary embodiments of the present invention may be achieved by a combination of hardware and software.

The processing device described herein may be implemented using hardware components, software components, and/or a combination thereof. For example, the processing device and the component described herein may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of reproducing an audio signal, the method comprising:
determining, when a user moves from a position to another position in a virtual space, a relative position between a sound source and the other position of the user using metadata based on a movement of the user; and
correcting a first audio signal obtained from the sound source at the position of the user to a second audio signal obtained from the sound source at the other position of the user based on the relative position.

2. The method of claim 1, wherein the metadata includes at least one of information on a virtual space including the sound source and information on a position of the sound source in the virtual space.

3. The method of claim 1, wherein the second audio signal is obtained by applying an acoustic effect corresponding to the other position to the first audio signal.

4. The method of claim 2, wherein the determining of the relative position comprises determining the relative position based on a direction and a distance between the user and the sound source using information included in the metadata.

5. The method of claim 1, wherein the correcting of the first audio signal comprises correcting the first audio signal to the second audio signal by applying a delay time and a gain based on the movement of the user.

6. The method of claim 5, wherein the delay time is determined by comparing a distance between the position of the user and the sound source and a distance between the other position of the user and the sound source and
the first sound signal is corrected to the second audio signal by applying the delay time.

7. The method of claim 5, wherein the gain increases when a distance between the position of the user and the sound source is less than a distance between the other position of the user and the sound source and
the gain decreases when the distance between the position of the user and the sound source is greater than the distance between the other position of the user and the sound source.

8. The method of claim 4, wherein the correcting comprises:
correcting, when the distance between the user and the sound source decreases, the first audio signal to the second audio signal such that a direct sound from the sound source increases and a reverberation decreases; or
correcting, when the distance between the user and the sound source increases, the first audio signal to the second audio signal such that the direct sound from the sound source decreases and the reverberation increases.

9. A method of generating an audio signal, the method comprising:
receiving an audio signal from a sound source located in a recording space; and
generating, when a user moves from a position to another position in a virtual space, metadata used for determining a relative position between the other position and the sound source based on a movement of the user.

10. The method of claim 9, wherein the metadata includes at least one of information on the virtual space including the sound source and information on a position of the sound source in the virtual space.

11. An apparatus for reproducing an audio signal, the apparatus comprising:
a processor,
wherein the processor is configured to:
determine, when a user moves from a position to another position in a virtual space, a relative position between a sound source and the other position of the user using metadata based on a movement of the user; and
correct a first audio signal obtained from the sound source at the position of the user to a second audio signal obtained from the sound source at the other position of the user based on the relative position.

12. The apparatus of claim 11, wherein the metadata includes at least one of information on a virtual space including the sound source and information on a position of the sound source in the virtual space.

13. The apparatus of claim 11, wherein the second audio signal is obtained by applying an acoustic effect corresponding to the other position to the first audio signal.

14. The apparatus of claim 12, wherein the processor is configured to determine the relative position based on a direction and a distance between the user and the sound source using information included in the metadata.

15. The apparatus of claim 11, wherein when correcting the first audio signal to the second audio signal from the sound source at the other position of the user, the processor is configured to correct the first audio signal to the second audio signal by applying a delay time and a gain based on the movement of the user.

16. The apparatus of claim 15, wherein the delay time is determined by comparing a distance between the position of the user and the sound source and a distance between the other position of the user and the sound source and
the first sound signal is corrected to the second audio signal by applying the delay time.

17. The apparatus of claim 15, wherein the gain increases when a distance between the position of the user and the sound source is less than a distance between the other position of the user and the sound source and
the gain decreases when the distance between the position of the user and the sound source is greater than the distance between the other position of the user and the sound source.

18. The apparatus of claim 14, wherein when the distance between the user and the sound source decreases, the processor is configured to correct the first audio signal to the second signal such that a direct sound from the sound source increases and a reverberation decreases or
when the distance between the user and the sound source increases, the processor is configured to correct the first audio signal to the second signal such that the direct sound from the sound source decreases and the reverberation increases.
